(19) United States
(12) Patent Application Publication
(10) Pub. No.: US 2003/0143998 A1
(43) Pub. Date: Jul. 31, 2003

(54) Wireless access system

(76) Inventor: Marc Frans Theeuwes, Menlo Park, CA (US)

Correspondence Address: MARC FRANS THEEUWES, 660 LIVE OAK AVE., MENLO PARK, CA, 94025, US

(21) Appl. No.: 10/057,094

(22) Filed: Jan. 28, 2002

(51) Int. Cl. H04Q 7/20

(52) U.S. Cl. 455/435; 455/560

(57) ABSTRACT

A wireless access system includes an Access Network Switching Unit (ANSU). Wireless stations use a plurality of wireless methods to access a network and services. An ANSU is notified as to the wireless station resource requirements and services requested. An ANSU triggers the switch of a wireless method used by a wireless station based on various factors.

### CROSS REFERENCE TO RELATED APPLICATIONS

U.S. Patent Documents

| Patent # | Date | Inventor(s) | Title | Field |
|---|---|---|---|---|
| 5,913,166 | Jun. 15, | Buttitta, | Arrangement for | 455/436 |
| | 1999 | Hilton, Khan | providing a call hand-off | |
| | | | for a wireless station | |
| | | | from a land-line | |
| | | | supported private base | |
| | | | station to a cellular base | |
| | | | station operating in a | |
| | | | cellular system | |
| 5,887,259 | Mar. 23, | Zicker, et al. | Multiple mode personal | 455/434 |
| | 1999 | wireless communications | | |
| | | | system | |
| 5,878,344 | Mar. 2, | Zicker | Module for selectively | 455/426 |
| | 1999 | providing wireless and | | |
| | | | wireless call | |
| | | | communication services | |
| 5,873,037 | Feb. 16, | Zicker | Multiple mode personal | 455/450 |
| | 1999 | wireless communication | | |
| | | | system | |

U.S. Patent Applications

| | | | | |
|---|---|---|---|---|
| 20010041 | Nov. | Jen-Chei; | Systems And Methods For | 455/406 |
| 553 | 15, 2001 | et al. | Providing Intelligent | |
| | | | Wireless Access Systems | |

### BACKGROUND

1. Field of Invention

This invention relates to a schema for enabling wireless stations to access a variety of services through a network using a plurality of wireless methods that are employed dynamically.

2. Background Description of Invention

The present invention provides a wireless access system. The wireless access system includes wireless stations [1], multiple wireless methods [2] connecting to a network or networks [3], an administration unit [4], an Access Network Switching Unit (ANSU) [5], and services [6]. See FIG. 1, “Wireless Access System Components”. The wireless system is intended to operate in conjunction with existing cellular networks, telephone networks and data networks. What is unique about this system is its use of an ANSU that works in conjunction with administration units and networks to optimize services delivered to wireless stations.

System design for this wireless access system is presented. People skilled in the art will appreciate that the components described are general and serve to illustrate and not limit the system and that the presented invention is only limited by the claims that follow.

In this system wireless stations use a plurality of wireless methods to access a network. A network can be, but is not limited to, a cellular network, telephony network, data network, or a communications network, collectively termed a network.

A wireless station can access a network with or without the support of an administration unit. For example, in the case of mobile cellular communications, the wireless station will request access to a network from the administration unit that would consist of some or all of the components of a cellular network such as Base Station (BTS), Base Station Controller (BSC), and Mobile Switching Center (MSC). In the case of wireless networking, a wireless station may access the network provided it has prearranged authorization or utilizes some open access scheme. A wireless station can also receive broadcast services, such as television, radio, and multimedia without the assistance of an administration unit.

Once a wireless station accesses a network, an ANSU is notified that said wireless station has accessed a network. As a wireless station requests services from a network, such as, but not limited to, telephony services, data services, Internet services, voice over Internet protocol (VOIP) services, multimedia services, broadcast services, or networking services, an ANSU monitors the services used. An ANSU will switch the wireless method used by the wireless station based on, but not limited to, services delivered, services requested, bandwidth required, power level, frequency, location, billing scheme, or another rule set by the administration unit or ANSU.

The ANSU switches the wireless method by issuing commands to the network that ensures service delivery through the various wireless methods. Wireless method switching can occur by switching the network employed, wireless transceiver [14], or the wireless method used by the wireless transceiver. See FIG. 4, “Wireless Architecture”. Some wireless methods may operate exclusively with one wireless transceiver as in Network_b of FIG. 4. In this case, the wireless method would be switched by altering the wireless transceiver used, or the network employed. In configuration Network_c of FIG. 4, the wireless method may be switched by a wireless transceiver that can deliver services through multiple wireless methods. In this case the wireless method switching would be accomplished by issuing commands to the wireless transceiver.

An ANSU can continually notify a wireless station and an administration unit, if employed, as to which wireless method is used. The administration unit may allow, or disallow a wireless station to use a wireless method and, therefore, limit access to certain services.

Optionally, notifications can be sent to a wireless station enabling the customer to monitor the wireless method and service used, so that the customer can make informed cost-effective decisions as to the service requested and wireless method used.

### BACKGROUND AND DESCRIPTION OF PRIOR ART

Technical Field

This invention relates generally to wireless stations operative with a network that provides a variety of services.

Background

Within wireless networking and communications there are several wireless access methods and protocols for communication. These facilitate communication between a wireless station and a host for the delivery of services between a wireless station and a host. With the increased use of various types of wireless communications methods (here termed “wireless methods”) and the growing popularity of wireless stations (mobile and non-mobile), increased flexibility in utilization of the variety of wireless methods is desired. This increases the ability to utilize frequencies and wireless methods at the point optimal for the services being provided, conserving power, increasing frequency reuse, and improving service delivery.

The cellular systems provide wireless stations with the ability to connect to a mobile wireless communications network. These systems utilize a variety of modulation schemes and multiple access techniques. These cellular systems provide telephony services for communications to mobile handset users, wireline telephony users, and other wireless devices. These networks also provide data services beyond telephony services, including but not limited to, email, Internet access, and access to data stored in legacy systems. Cellular systems operate in various frequency ranges.

Wireless networking methods enable units utilizing a transceiver to access a network wirelessly. These systems operate with a variety of protocols, for example, wireless Ethernet or satellite networking.

In addition to networking and cellular services, there are a variety of additional wireless communications methods, including but not limited to methods utilized by television, radio, and cordless phones.

For the purposes of following discussions, the above methods are collectively called wireless methods. The wide variety of services, for example, but not limited to, telephony, data, television, and radio, accessed by a wireless station are collectively called services.

The expansion of the types of wireless stations accessing a wide variety of services is enabled by a wide variety of wireless methods. Many wireless methods are particular to a certain network or service used. In order to provide a wider variety of services to wireless stations under various conditions, support for wireless method switching is desired. This requires the ability to switch among various wireless methods based on certain factors. For example, some services are better provided by one wireless method than another or are better provided by some mix of wireless methods due to, but not limited to, signal power, carrier to noise ratio, frequency, modulation technique, or bandwidth.

Description of Prior Art

The purpose of U.S. Pat. No. 5,913,166 is to specify the methods for switching the communications channel between a cell phone and a private cell base station to the PSTN (Public Switched Telephone Network) in the event that the wireless station is near the fringe of the coverage area provided by the private base station. Methods discuss the details of this switching system as they pertain to telecommunications as specified by the Telecommunications Industry Association (TIA) Interim Standard (IS)-136, dated Nov. 17, 1995. In addition, the private base stations specified operates in accordance with the TIA IS-136 cellular radio interface specification and share the same frequency spectrum with large cells in the public cellular system. Thus, there is no change in frequency spectrum or wireless method. Further the purpose of U.S. Pat. No. 5,913,166 is to enable a telecommunications call to continue. This patent invention application specifies that the ability to alter the wireless method is central to the novelty of this patent application. Further, the intent of this patent invention application is to enable wireless methods to be altered based on service type, which is different from the purpose of patent U.S. Pat. No. 5,913,166. The goal of the invention in U.S. Pat. No. 5,913,166 is to provide seamless telecommunications support. The invention presented in U.S. Pat. No. 5,913,166 provides for an arrangement for configuring a private base station with a telephone call hand-off capability to support continued telecommunications. U.S. Pat. No. 5,913,166 does not address the ability of an intelligent control unit to change the wireless method depending on various constraints or services as is specified in this patent invention application. The arrangement described in U.S. Pat. No. 5,913,166 could operate in a complementary fashion to that described in this patent invention application but is significantly different in its scope and ramifications.

U.S. Pat. No. 5,887,259 and related U.S. Pat. Nos. 5,878,344 and 5,873,037 specify a wireless communications system that allows the mobile handset communications to be switched from a cellular network to an advanced cordless system when handsets are in the range of the advanced cordless network of pico cells. Specifically, switching occurs as a result of power levels. The patent mentions “special handsets designed to operate with standard analog or digital protocols when within the coverage of a standard cellular radio telephone network”, implying that the frequencies are limited to frequencies used by cellular networks and cordless phones. In addition, the patent specifies that the pico cells are “low power ‘pico’ cells that are connected to the wireline telephone network.” in the case of this patent invention application, there is no limitation to the power output of mobile method and no requirement that the mobile method be connected to the wireline telephone network. For example, a wireless Ethernet network (such as 802.11 or HomeRF) is typically connected to a data network, such as but not limited to a Wide Area Network (WAN), Local Area Network (LAN), or the Internet. The goal of U.S. Pat. No. 5,887,259 and its related patents is to enable a wireless station to used a pico cell for the delivery of the same service, telecommunications. This patent invention application calls for support of services of data and telecommunications networks to expand the services offered to wireless stations. U.S. Pat. No. 5,887,259 does not address the ability of an intelligent control unit to change the wireless method depending on various constraints or services as is specified in this patent invention application. In similar fashion to U.S. Pat. No. 5,913,166, the invention in U.S. Pat. No. 5,887,259 would operate in a complementary fashion to the invention presented in this patent invention application and is significantly different in its scope and ramifications.

Patent application 20010041553 specifies use of a microcell switch between the microcell and the cellular network. This supports the integration of wireless telephony service with wire-based telephony service such that incoming calls can be handled by a wirebased telephone or a cellular units. The patent addresses the ability to support incoming telecommunications calls to two possible channels, the wireline and cellular telecommunications networks. Patent application 20010041553 does not address the ability of an intelligent control unit to change the wireless method depending on various constraints or services as is specified in this patent invention application. The uniqueness of this patent invention application is that it facilitates delivery of services through multiple networks. This patent invention application also illustrates the ability of the ANSU to alter the wireless method depending on requirements in a network, service, and also requirements at a wireless station.

### OBJECTS AND ADVANTAGES

Several objects and advantages of this patent invention application are:

1. to enable a multiple of frequencies to be used to optimize the cost of providing a service to a wireless station or plurality of wireless stations.

2. to enable the consumer to choose from a variety of wireless methods such that they can control the cost and/or quality of service provided.

3. to enable the administration unit to control the quality and/or cost of a service provided.

4. to make available Multiple wireless methods such that power consumption at the wireless station can be optimized

5. to make available multiple wireless methods such that power consumption can be optimized at the network.

6. to provide multiple wireless methods such that service delivery can be made redundant for access through a plurality of wireless methods enhancing among other things, quality of service and fault tolerance.

7. to enhance the utility of the wireless station for delivery of a single or plurality of services over a “best choice” wireless method.

8. to enable seamless integration of wireless methods.

9. to enhance the utility of the wireless station by enabling it to access the same servicer or multiple services over multiple networks and wireless methods.

10. to enable an intelligent rule-set to govern the wireless methods used allowing-network resources to be utilized at various levels, improving services delivered to wireless stations.

### DRAWING FIGURES

FIG. 1—Wireless Access System Components

FIG. 2a—Protocol Flow

FIG. 2b—Protocol Flow (continued)

FIG. 3—ANSU configuration

FIG. 4—Wireless Architecture

### REFERENCE NUMERAL IN DRAWINGS

[1] wireless stations

[2] multiple wireless methods

[3] network or networks

[4] administration unit

[5] Access Network Switching Unit (ANSU)

[6] multiple services

[7] data storage

[8] random access memory

[9] microprocessor

[10] interface to networks

[11] interface to wireless methods

[12] interface to keyboard, mouse and screen

[13] software systems

[14] wireless transceiver

### DETAIL DESCRIPTION IF INVENTION AND FIGURES

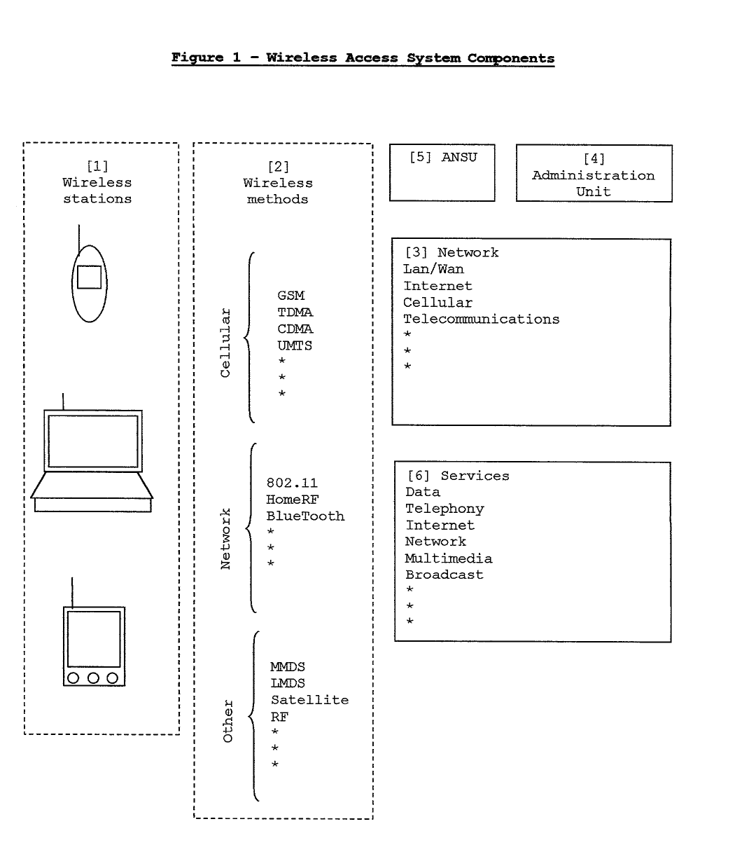

A typical embodiment of the wireless access system is illustrated in FIG. 1 Wireless stations [1] can be of any configuration, For example, these can be cellular phones, laptops, or Personal Digital Assistants (PDAs). Wireless stations can also be devices that are enabled to communicate Twirelessly utilizing some wireless communications device, such as a wireless local area network interface card. Wireless methods [2] are any method of transmission using electromagnetic waves utilizing a variety of protocols, frequencies, and modulation techniques Wireless methods can be used in combination. A network [3] can be any wireless network, for example, local area network, cellular network, or broadcast network. The network constitutes the physical layer of the system that utilizes some combination of wireless method to deliver information. The administration unit [4], optionally controls the wireless station ability to access services. An administration unit may also contain the rules that dictate how a wireless station is to access a network or service. An ANSU [5] controls the switching of a wireless method and network. An ANSU may interface with the administration unit if such administration unit is required to enable a wireless station to access a network. Services [6] are provided through a network to the wireless stations.

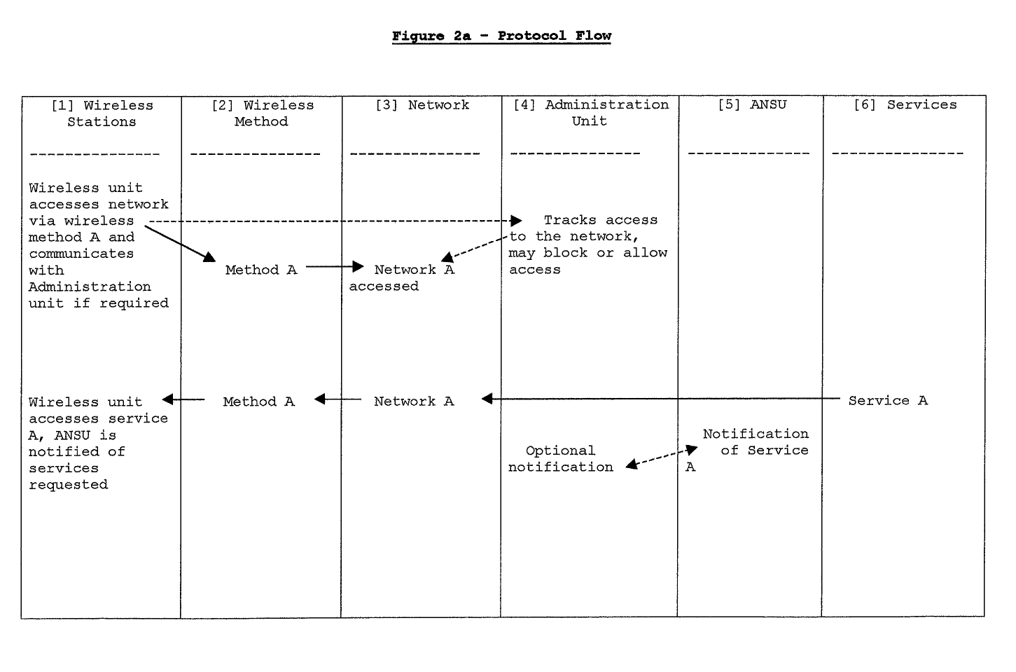

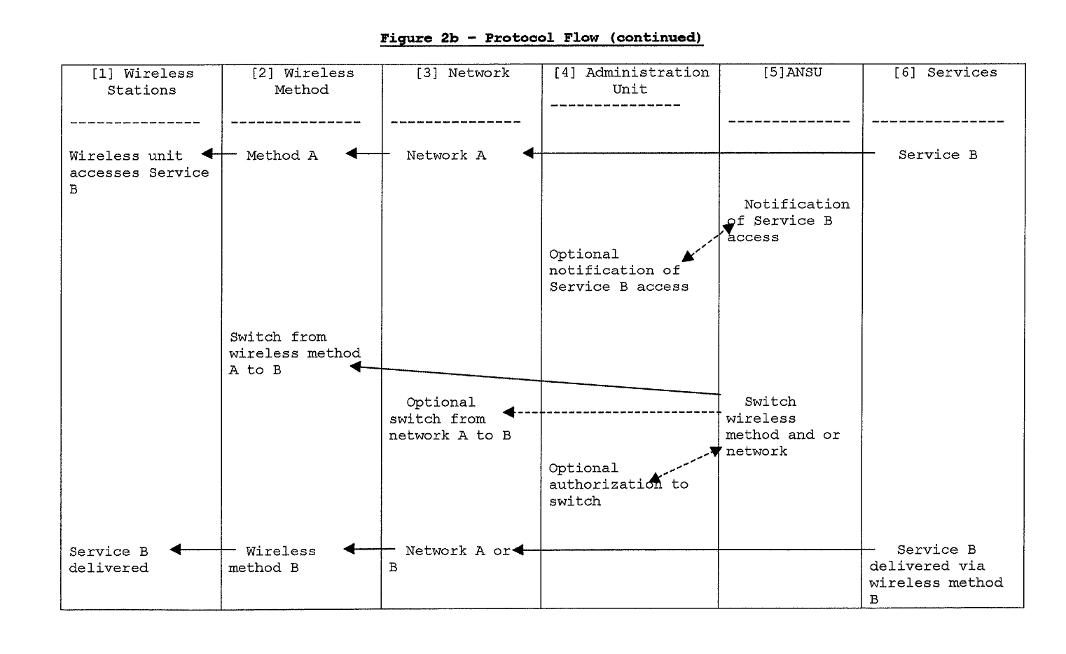

FIG. 2 illustrates the protocol for switching the wireless method and network. A wireless station [1] accesses a network utilizing a wireless method. It communicates with an administration unit, if required, for access to the network. Once access is established an ANSU is notified that said wireless station has accessed the network. Once access to the network has been established; said wireless station accesses service As ANSU is notified that service A has been accessed by said wireless station either by said wireless unit, service A, the administration unit or by monitoring a network.

Said wireless unit then proceeds to access service B. An ANSU is notified that said wireless station requests service B. An ANSU decides to switch a wireless method and or network. If an administration unit is present, said ANSU could communicate with it in the event that said administration unit is required to provide authorization information. An ANSU triggers the switching of a wireless method from A to B and, optionally, a network is switched from A to B. Service B is provided to said wireless station via wireless method B and network A or B. In this example, switch of the wireless method was triggered by the wireless station's request for service. The switch could also be initiated by the ANSU in support of multiple services, or optimal services, delivered to the wireless stations.

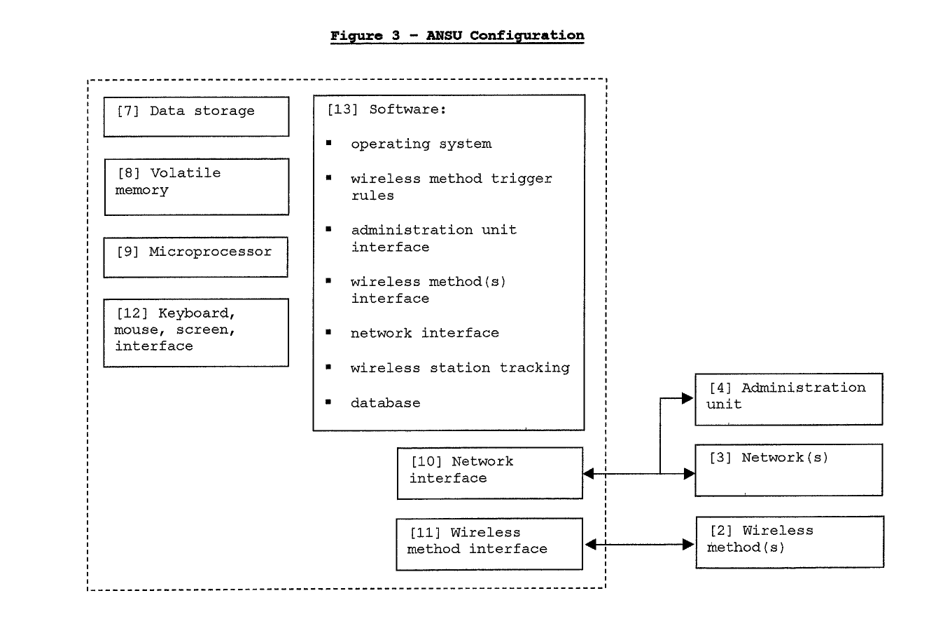

An ANSU configuration is shown in FIG. 3 “ANSU Configuration.” It contains a data storage [7] element for storing data, the operating system and software. A data storage element can be composed of a hard drive, an array of hard drives or a networked storage element. Random access memory [8] supports operation of the operating system and system software when an ANSU is in operation. A microprocessor [9] executes functions of an operating system, software and various hardware devices. It can be implemented as a RISC (reduced instruction set computer), CISC (complex instruction set computer or computing), or other microprocessor suitable for performing the functions required of an ANSU.

A network interface [10] is a hardware device suitable for managing communications to a network or multiple networks [3]. Communications to and from an administration unit [4] is accomplished via a network. Therefore, an ANSU is also shown connecting to an administration unit through a network interface. It can be a network interface card for communicating to, for example, a local area network (LAN) or a wide area network (WAN). A wireless method interface [11] is a hardware device suitable for managing communications for switching the various wireless methods [2]. A keyboard, mouse and screen interface [12] allows optional user interface devices to be connected to an ANSU, such that an operator can program the ANSU and perform various operations and maintenance tasks. ANSU software [13] contains the generic and specialty software components that control the various hardware components of an ANSU. The ANSU software consists of a process for operating a general purpose computing device to enable said computing device to execute commands in a program based on a combination of data. An alternate configuration to this is that ANSU software can reside in the same computing system that contains the administration unit [4] or the service [6].

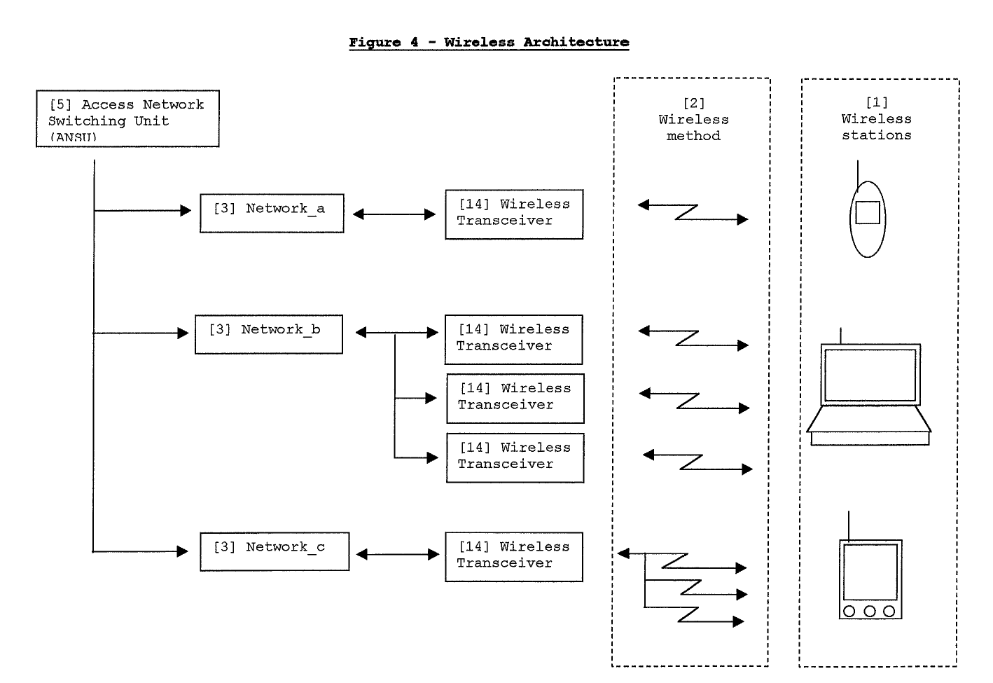

FIG. 4 illustrates a wireless architecture that shows an ANSU [5] relation to networks [3] and wireless transceivers [14] employed. The ANSU communicates through some type of network in order to initiate a wireless method switch. Ultimately these commands control a wireless transceiver that relays information through the wireless method [2] to the wireless stations [1]. In practice there are many configurations that could occur due to multiple types of networks, wireless transceivers, and wireless methods. Some example configurations are shown in FIG. 4 Network_a, Network_b, and Network_c.

Persons skilled in the art will appreciate the flexibility to develop the systems in a way that meets the needs of their customers given the architecture of their systems.

### SUMMARY, RAMIFICATIONS, SCOPE

This invention presents a wireless system where wireless method switching and network switching provides the ability to cater the wireless method and network to a variety of factors. The ability to switch the wireless method can improve the delivery of service. It can allow services to be scaled based on the level of service requested by the wireless station. Bandwidth and power requirements can be used to switch the wireless method. This allows conservation of limited network resources. It allows network resources to be scaled based on need and cost.

Although the description above contains much specificity, these should not be considered as limiting the scope of the invention but as providing illustration of a preferred embodiment of this invention. The invention can be practiced otherwise than as specifically illustrated and described without departing from its scope.

I claim:

1. A wireless access system arranged for providing a plurality of wireless methods for a wireless station operable in said wireless access system for accessing a plurality of services, the system comprising:

2. a access network switching unit,

3. means for switching said wireless methods.

4. The wireless access system of claim 1 wherein said wireless access system includes a plurality of networks, and

5. said networks employ said wireless methods as the medium for access to said network.

6. The wireless access system of claim 1 wherein said switching means is controlled by said access network switching unit, and

7. said access network switching unit consists of a process for operating a general purpose computing device to enable said computing device to execute commands in a program based on a combination of data, and

8. said wireless method is switched based on a result produced by said program.
